(19) United States
(12) Patent Application Publication
(10) Pub. No.: US 2008/0002897 A1
(43) Pub. Date: Jan. 3, 2008

(54) METHOD AND SYSTEM FOR PARALLEL OPTICAL DECODING OF DIGITAL PHASE IMAGE TO INTENSITY IMAGE

(75) Inventors: PAL KOPPA, Budaors (HU); JUDIT REMENYI, Budapest (HU); FERENC UJHELYI, Mogyorod (HU); GABOR ERDEI, Budapest (HU)

Correspondence Address: Womble Carlyle Sandridge & Rice, PLLC;Attn: Patent Docketing 32nd Floor, P.O. Box 7037, Atlanta, GA, 30357-0037, US

(73) Assignee: Bayer Innovation GmbH, Dusseldorf (DE)

(21) Appl. No.: 11/766,490

(22) Filed: Jun. 21, 2007

(30) Foreign Application Priority Data
Jun. 30, 2006 (EP) 06013569.6

(51) Int. Cl. G06K 9/36

(52) U.S. Cl. 382/233

(57) ABSTRACT

The present invention relates generally to a method for parallel optical decoding of a digital phase image to an intensity image by algorithmic encoding of a data page into phase image and parallel optical decoding by capturing the interference of the phase data page and its copy shifted by one or a few pixels with respect to each other.

### CROSS REFERENCE TO A RELATED APPLICATIONS

This application claims priority from European Patent Applicatoin No 06013569.6, filed Jun. 30, 2006, the content of which is incorporated herein by reference in its entirety.

### BACKGROUND OF THE INVENTION

1. Field of the Invention

The present invention relates generally to a method for parallel optical decoding of a digital phase image to an intensity image by algorithmic encoding of a data page into a phase image and parallel optical decoding by capturing the interference of the phase data page and its copy shifted by one or a few pixels with respect to each other.

2. Description of Related Art

In optical data storage, a recording light beam is typically modulated according to the data to be stored. When data is stored on a recordable CD or DVD, the recording light beam is switched on and off according to the binary data stream. Thus the amplitude of the light beam is temporally modulated. Similarly, when data is read-out optically, the amplitude of a light beam is also modulated temporally.

In holographic data storage, an object beam and a reference beam are overlapped within a holographic storage medium. Overlapping the two beams leads to an interference pattern, which is recorded within the storage medium. The object beam is modulated using a spatial light modulator (SLM) according to the data to be stored. In contrast to the temporal modulation of recording light beam in serial writing of bits on a recordable CD or DVD, a spatial modulation of recording light beam is applied in holographic data storage. But again, the amplitude of light is modulated according to the data to be stored. When the hologram is illuminated by the reference beam to read out the data, the object beam is reconstructed, which shows a spatial amplitude modulation.

Besides the modulation of amplitude of a light beam, there are other options, to encode data with a light beam, e.g. phase modulation.

Optical data storage using phase modulation is not common. But there are many advantages, especially in holographic data storage:
1. In case of Fourier hologram recording, i.e. if the recording holographic plate is at Fourier plane of the object to be recorded, the Fourier transformation of an amplitude object often leads to a very inhomogenous intensity distribution. This might cause some problems, because some areas of the holographic plate might be overexposed whereas other areas might be underexposed. The intensity distribution of the optical Fourier transform of phase object can be more homogeneous than of an intensity object, thus in case of Fourier hologram recording, phase objects can be more effectively recorded (GB patent 1320538).
2. For secure storage the encryption of the data in recording is needed (U.S. Pat. No. 5,940,514). It can also be made more effective by use of phase object (Nomura, Javidi AO Vol. 39 2000).
3. Holographic storage is also well suited to fast associative readout (searching the memory by content), which shows much better properties for phase images (Renu John, Joby Joseph, Kehar Singh: Phase-image-based content-addressable holographic data storage, Opt. Comm. 232, 2004).

But there might be some problems, when using phase modulation for holographic data storage. When reconstructing the hologram, the spatial phase distribution of the diffracted wave front needs to be decoded into intensity modulation to be visualized or captured by a detector such as a CCD camera.

For this phase to intensity conversion interferometric techniques can be used, such as Mach-Zehnder interferometer using reference wave (Seo, Kim OL Vol 29 2003) or phase contrast imaging with common path interferometer (U.S. Pat. No. 6,011,874).

For the observation of phase objects (e.g. cells) the most popular method is Differential Interference Contrast (DIC) microscopy (FR Patent 1.059.123).

### SUMMARY OF THE INVENTION

An object of the present invention, was to provide a novel method and system for parallel optical decoding of a digital phase image to an intensity image, which is very simple, easy to implement and which works without complex hardware, (i.e. without using a Differential Interference Contrast (DIC) microscope, for example).

This object was surprisingly capable of being achieved by a method according to the present invention explained in detail below.

The present invention therefore relates to a method for algorithmic encoding of a data page (array of 1's and 0's or digital numbers) into a phase image, and parallel optical decoding by capturing the interference of the phase data page and its copy, shifted by one or a few pixels with respect to each other. The 2 dimensional phase data page comprises of discrete pixels of phase shifts: Φ_{i,j}; if the absolute value of the amplitude is constant (E₀) the electric field is E(xᵢ, yⱼ)=E_{i,j}ⁱⁿ=E₀·exp(i·Φ_{i,j}) For example, the application of a diagonal shift of one pixel to the left and one pixel down can be described by the electric field of the input image Eᵢₙ according to equation 1:

E_{i,j}^{out}=E_{i,j}ⁱⁿ+E_{i+1,j+1}ⁱⁿ (1)

If the pixels of the input image are encoded with a 0 and a π phase, the possible electric field values are E_{i,j}ⁱⁿ=E₀·e^{i·0}=E₀ and E_{i,j}ⁱⁿ=E₀·e^{i·π}=−E₀ respectively, and the output field is either 0 or ±2·E₀. The output intensity is proportional to either 0 or 4·E₀², so we obtain a simple binary intensity image:

I_{i,j}^{out}∝|E_{i,j}^{out}|²=|E_{i,j}ⁱⁿ|²+|E_{i+1,j+1}ⁱⁿ|²+E_{i,j}ⁱⁿ*·E_{i+1,j+1}ⁱⁿ+E_{i,j}ⁱⁿ·E_{i+1,j+1}ⁱⁿ*=E₀²(2±2) (2)

Additional objects, features and advantages of the invention will be set forth in the description which follows, and in part, will be obvious from the description, or may be learned by practice of the invention. The objects, features and advantages of the invention may be realized and obtained by means of the instrumentalities and combinations particularly pointed out in the appended claims.

### BRIEF DESCRIPTION OF THE DRAWINGS

FIGS. 1-8 depict exemplary embodiments of the present invention.

### DETAILED DESCRIPTION OF A PREFERRED EMBODIMENT

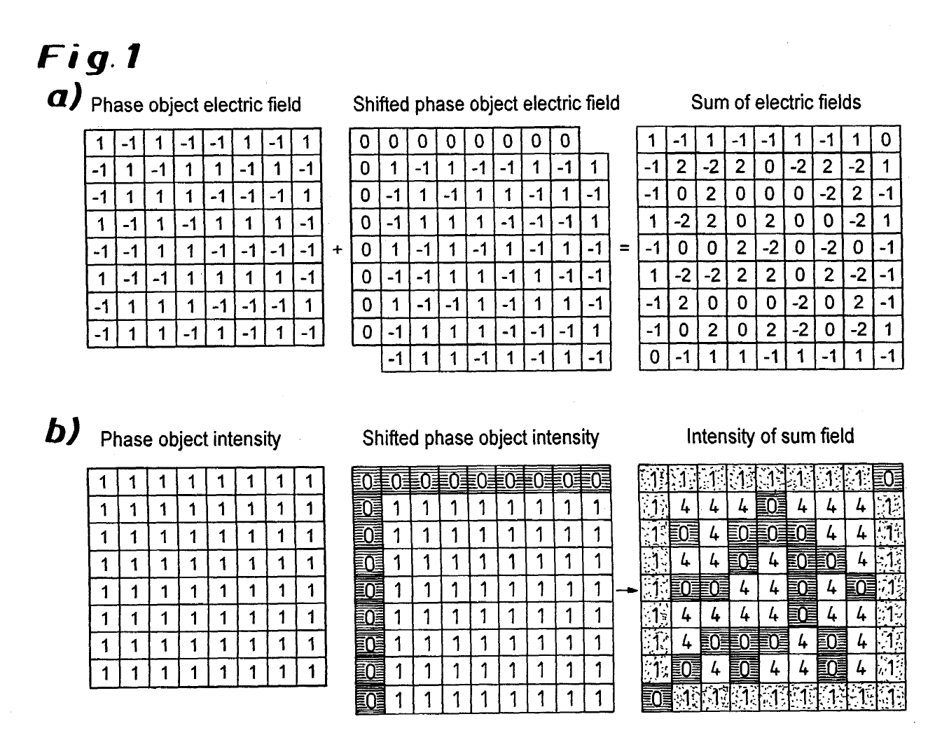

FIG. 1 shows the principle of a suitable technique on a simple image according to the present invention. Due to the limited size of the arrays, the boarder of the output image is not a real interference as only one phase image is present. Thus the output image does not carry information, but the N−1 by N−1 core of the output represents the binary data according to equation (2).

Any digital data page can be coded into a phase image according to the following simple recursive formula shown in equation (3) based on an inversion of equation (1):

E_{i+1,j+1}ⁱⁿ=E_{i,j}^{out}−E_{i,j} (3)

If a D_{i,j} binary data page (consisting of elements of 0 and 1) is needed to be generated at the output (the intensity is I_{i,j}^{out}=I₀·D_{i,j} where I₀ is a constant intensity), the recursive formula for the binary input phase page (consisting of elements of 0 and π phases) is:

Φ_{i+1,j+1}=(Φ_{i,j}/π+D_{i,j}−1)

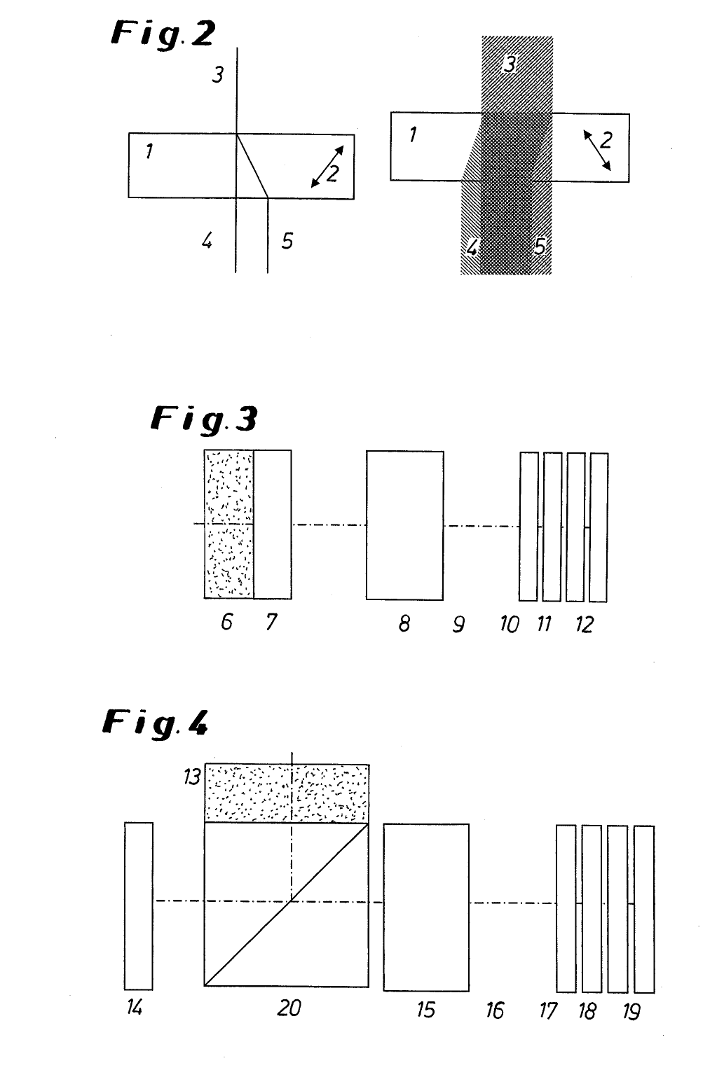

The image duplication and shift can be implemented by different optical solutions like a birefringent plate (as shown in FIG. 2). If the birefringence axis is not parallel to the propagation direction of the incident beam, the propagation direction of the ordinary and the extraordinary polarization components is typically different, and thus the extraordinary component is laterally shifted after traversing the plate. In this way, two phase images with orthogonal polarization are present after being subjected to the birefringent plate. For making them interfere, a polarizer with polarization a axis angular to both the ordinary and the extraordinary polarization direction can be introduced. The interference pattern then can be captured by a CCD camera, for example. (See i.e. the optical systems of FIG. 3 and 4.)

The birefringent plate introduces constant phase shifts to the images, which can be different for the ordinary and the extraordinary images. The difference between the phase shifts can be adjusted by slightly turning the plate from perpendicular incidence. If the phase difference is 0 or an integral multiple of 2π, the above equations are valid. If the phase shifts are opposite i.e. the difference is π or an odd multiple of π, the interference of the points with the same initial phases is dark, and the interference of points with initially different phases is bright. This adjustment is advantageous, for example because a high contrast output image can be achieved even if the phase levels of the input images are not perfectly 0 and π.

FIG. 1 demonstrates how a phase coded image is decoded to an intensity image. FIG. 1a) shows the complex amplitude of the phase coded image (containing values of 1 and −1 corresponding to phases of 0 and π), its spatially shifted replica and the coherent sum of them. FIG. 1b) shows the absolute value square of the amplitudes of FIG. 1a) presenting the corresponding intensities. The first image table presents the intensity of the phase coded image, which is constant, the second is its spatially shifted replica, and the third is the intensity distribution of their interference. The inner part of the resultant image contains intensities of 0 and 4 providing the decoded binary image.

FIG. 2 shows how a birefringent plate (1) can duplicate and shift an image by double refraction. In case of normal incidence, the ordinary polarization component (4) of the incident beam (3) traverses the plate without refraction, and the extraordinary one (5) is refracted at the incidence plane, propagates angularly in the plate, and exits from the plate in a parallel direction, but shifted to the ordinary one. Also shown in FIG. 1 is the optical axis (2) of the birefringent plate.

FIG. 3 shows an embodiment of the decoding optical system using a birefringent plate for image duplication and shift in case of a transparent phase object. The encoded phase image can be generated with a phase modulating spatial light modulator (7) illuminated with a polarized plane wave (7). The imaging optics (8) projects the image of the phase object to the detector plane (12), and the image duplication and shift is made just before this plane (12). The birefringent plate (10) splits and shifts the extraordinary polarization from the ordinary one as shown in FIG. 2. The ratio of the intensities in the two beams is adjusted with the half-wave plate (9), and the polarizer (11) polarizes the two beams to the same direction in order to make them interfere, giving a decoded intensity pattern.

FIG. 4 shows an embodiment of the decoding optical system using a birefringent plate for image duplication and shift in the case of a reflective phase object. The encoded phase image can be generated with a reflective phase modulating spatial light modulator (14) illuminated with plane wave (13) polarized by a polarizing beam splitter (20) which transmits the orthogonal polarization reflected from the phase modulating spatial light modulator (14) which may include, for example, a wave retarder to adjust the proper polarization. The imaging, shifting and capturing part is generally the same as in FIG. 3. The imaging optics (15) project the image of the phase object to the detector plane (19), and the image duplication and shift is made just before this plane (19). The birefringent plate (17) splits and shifts the extraordinary polarization from the ordinary one as shown, for example, in FIG. 2. The ratio of the intensities in the two beams is adjusted with the half-wave plate (16), and the polarizer (18) polarizes the two beams to the same direction in order to make them interfere, giving the decoded intensity pattern.

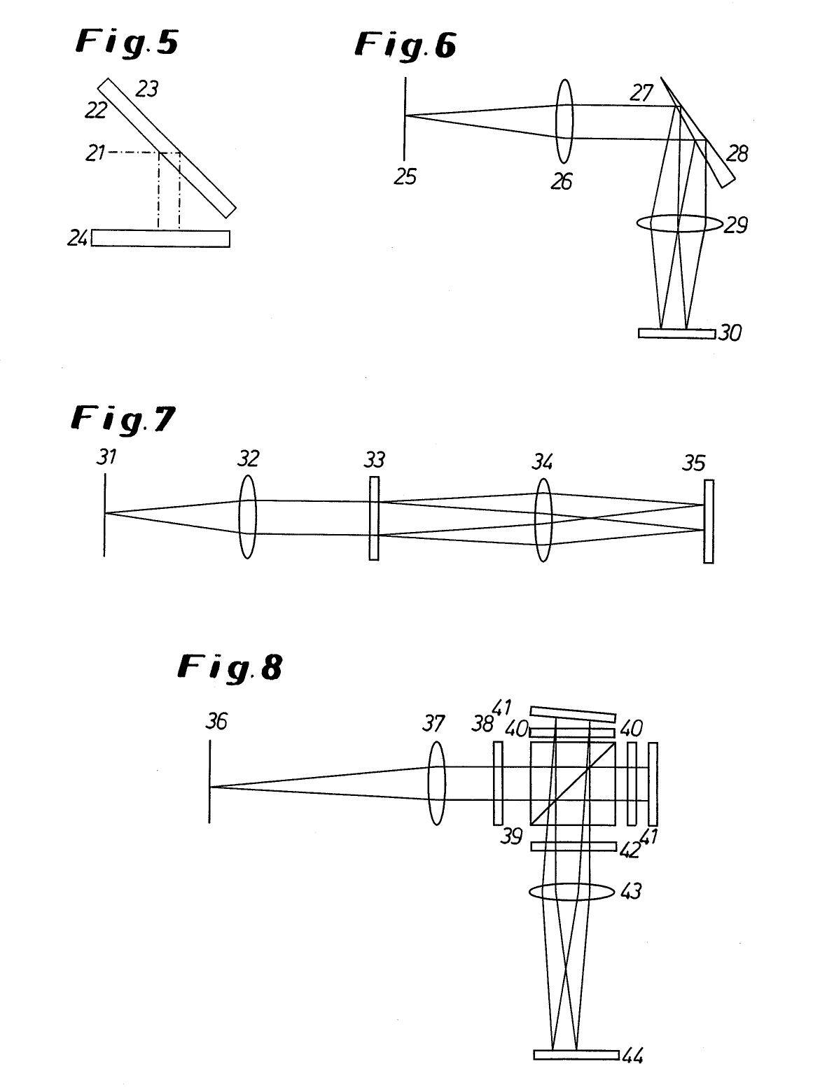

FIG. 5 shows an embodiment of the decoding optical system using a plan-parallel plate with a partly reflecting mirror and a totally reflecting mirror for image duplication and shift. The encoded phase image carried by the laser beam (21) is imaged on the detector plane (24), and the image duplication and shift is made just before this plane (24). One portion of the beam is reflected on a front mirror (22) which is partly reflecting; the other part is reflected on a rear mirror (23) which is totally reflecting. The two beams interfere at the camera plane, giving a decoded intensity pattern.

FIG. 6 shows an embodiment of the decoding optical system obtained by splitting the light beam and introducing angular shift between the beams at the Fourier plane of the phase image by a small angle prism with a partly and a totally reflective surface. The phase image (25) is generally at the front focal plane of the Fourier transforming lens (26), and at the back focal plane of the lens, a partly reflective mirror (27) reflects one part of the beam carrying the Fourier transform of the phase image, and the other part is reflected on a totally reflective mirror (28) in an angularly shifted direction. The second Fourier transforming lens (29) gives the image plane (30) in its back focal plane, where the angular shift in the Fourier plane is transformed into spatial shift, and the two shifted images interfere in order to produce the intensity pattern.

FIG. 7 shows an embodiment of the decoding optical system obtained by splitting the light beam and introducing angular shift between the beams at the Fourier plane of the phase image by a diffracting or by a Wollaston prism. The phase image (31) is at the front focal plane of the Fourier transforming lens (32), and at the back focal plane of the lens, a diffraction grating or a Wollaston prism (33) splits the beam carrying the Fourier transform of the phase image, and introduces angular shift between the two beams. The second Fourier transforming lens (34) gives the image plane (35) in its back focal plane, where the angular shift in the Fourier plane is transformed into spatial shift, and the two shifted images interfere to produce the intensity pattern. If a Wollaston prism is used to split the beam into two with orthogonal polarization, a polarizer can advantageously be placed at the image plane with intermediate direction to make them interfere.

FIG. 8 shows an embodiment of the decoding optical system obtained by splitting the light beam and introducing angular shift between the beams at the Fourier plane of the phase image by a polarization beam splitter prism and two mirrors. The phase image (36) is at the front focal plane of the Fourier transforming lens (37), and at the back focal plane of the lens (that is, the Fourier transform of the phase image), the beam is split into two and an angular shift is introduced between the two beams with the following advantageous setup. A polarization beam splitter prism (39) splits the beam; the intensity ratio of the transmitted and the reflected beams is set by a half-wave plate (38). Both the transmitted and the reflected beams are reflected back by a quarter-wave plate (40) and a mirror (41) at both sides of the prism, and then they come out from the prism with a small angle shift between them that is up to 5-10° or less. The two beams are of orthogonal polarization so a polarizer (42) with intermediate axis makes them able to interfere. The second Fourier transforming lens (43) gives the image plane (44) in its back focal plane, where the angular shift in the Fourier plane is transformed into spatial shift, and the two shifted images interfere to produce the intensity pattern.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

The use of singular article terms including “an”, “a” and “the” can connote the singular or plural of the object that follows.

1. A method for decoding a phase image to encode an intensity image I(x′,y′) wherein said phase image comprises at least one phase element Φ(xₘ,yₙ) and parallel optical decoding, said decoding method comprising duplicating the phase image and capturing an interference pattern of the phase image element Φ(xₘ,yₙ) with a spatially shifted replica Φ(xₘ₊ₐ,y_{n+b}) thereof.

2. A method according to claim 1, wherein said intensity image I(x′,y′) is binary according to I(x′,y′)=I₀D_{m′,n′}, wherein I₀ is a constant intensity and D_{m′,n′} is a digital page comprising 0's and 1's, and said phase image element Φ(xₘ,yₙ) is binary, and an encoding recursive formula is Φ_{m+a,n+b}=π·(Φ_{m,n}/π+D_{m′,n′}−1).

3. A method according to claim 2, wherein the intensity of the phase image is homogeneous, and the interference pattern comprises domains of two intensity levels comprising 0 and 1 data of said D_{m′,n′} digital page.

4. A method according to claim 1, wherein the intensity image I(x′,y′) to be encoded is multi-grayscale-leveled, it being possible to form one encoded image or more than one encoded image, each possessing the same decoded image by optical decoding.

5. A method according to claim 1, wherein the phase shift difference between corresponding points of two phase images is 0 or an even multiple of 2π, and encoded image points are bright and dark if initial phases of interfering points are equal and opposite respectively.

6. A method according to claim 1, wherein the phase shift difference between corresponding points of two phase images is π or an odd multiple of π, and encoded image points are dark and bright if initial phases of interfering points are equal and different respectively.

7. A method according to claim 1, wherein said duplicating comprises splitting and shifting a light beam in an image plane.

8. A method according to claim 7, wherein splitting the light beam and shifting the image are accomplished by a birefringent plate and the capturing of the interference comprises polarizing two orthogonally polarized images to a mediate polarization direction.

9. A method according to claim 7, wherein splitting the light beam and shifting the image are accomplished with at least one partly reflective and at least one totally reflective mirror, each parallel to the other.

10. A method according to of claim 7, wherein duplicating and spatial shifting of the phase image is accomplished by splitting the light beam and introducing angular shift between two beams at a Fourier plane of the phase image.

11. A method according to claim 10, wherein splitting the light beam and introducing angular shift between the two beams are accomplished with a Wollaston prism.

12. A method according to claim 10, wherein splitting the light beam and introducing angular shift between the two beams are accomplished with beam splitter gratings.

13. A method according to claim 10, wherein splitting the light beam and introducing angular shift between the two beams are accomplished with a polarization beam splitter, mirrors and wave retarders.

14. A method according to claim 10, wherein splitting the light beam and introducing angular shift between the two beams are accomplished with at least one partly reflective mirror and at least one totally reflecting mirror.

15. A method according to claim 1, wherein an encoded phase image is generated by a spatial light modulator.

16. A method for optical data storage comprising the encoding and parallel optical decoding method according to claim 1.

17. An apparatus for decoding a phase image to encode an intensity image I(x′,y′), said phase image comprising at least one phase element Φ(xₘ,yₙ) and parallel optical decoding, said apparatus comprising at least one means for splitting and shifting a light beam in an image plane selected from the group consisting of a birefringent plate and an arrangement of a partly reflective mirror and a totally reflective mirror parallel to each other.

18. An apparatus for decoding a phase image to encode an intensity image I(x′,y′), said phase image comprising at least one phase element Φ(xₘ,yₙ) and parallel optical decoding, said apparatus comprising at least one means for splitting a light beam and introducing angular shift between two beams at a Fourier plane of the phase image, said at least one means for splitting being selected from the group consisting of a Wollaston prism, beam splitter gratings, an arrangement of a polarization beam splitter, mirrors and wave retarder and an arrangement of partly and totally reflecting mirrors.

19. A method for parallel optical decoding of a digital phase image to an intensity image comprising:
algorithmically encoding a data page into a phase image,
parallel optically decoding said phase image by capturing the interference of a phase data page of said phase image and a shifted copy of phase data page, said shifted copy being shifted by at least one pixel with respect to said phase data page,
and obtaining said intensity image based on said captured interference.

20. An intensity image that has been obtained according to a method of claim 19.
